(19) United States
(12) Patent Application Publication
(10) Pub. No.: US 2010/0002869 A1
(43) Pub. Date: Jan. 7, 2010

(54) ENCRYPTION CIRCUIT AND DECRYPTION CIRCUIT

(76) Inventor: Atsushi TORAI, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/167,726

(22) Filed: Jul. 3, 2008

(30) Foreign Application Priority Data
Sep. 14, 2007 (JP) JP2007-240076

(51) Int. Cl. H04L 9/28

(52) U.S. Cl. 380/28

(57) ABSTRACT

A CBC encryption circuit, configured with an input register 11, a KEY register 12, an EXOR calculation section 13, an AES encryption calculation section 14, a sector 15, an IV register 16 to hold an initial vector IV and output register 17, is equipped with a counter 22 to count the number of encryption times, a cycle register 23 in which the number of encryption times in one cycle is set and a comparison function section 24 to output an enable signal 35 and reset the counter 22, in case the count value of the counter 22 at a first encryption and within the set cycle, agrees with the number of encryption times in one cycle. A selector 15 selects the initial vector IV if the enable signal 35 is inputted and selects an output of the AES encryption calculation section 14 if the enable signal is not inputted.

This application is based on Japanese Patent Application No. 2007-240076 filed on Sep. 14, 2007, in Japanese Patent Office, the entire content of which is. hereby incorporated by reference.

### BACKGROUND OF THE INVENTION

The present invention relates to an encryption circuit to encrypt a plain text and a decryption circuit to decrypt a cipher text.

Generally, encryption of data is required a high security level and capability of high speed processing. A main stream of encryption scheme has been shifting from DES (Digital Encryption Standard) to AES (Advanced Encryption Standard) and cipher strength has been enhanced. AES encryption scheme representing a block cipher where data is encrypted and decrypted in a block length unit of 128 bit has a plurality of modes which are selected in accordance with a purpose or usage.

FIG. 7 shows an exemplary configuration of an encryption circuit 300 of CBC (Cipher Block Chaining) mode. The encryption circuit 300 is provided with an AES encryption calculation section 301 to apply encryption calculation based on AES standard for an input value and outputs a result of calculation (encryption vector), a KEY register 302 to hold a encryption key to be inputted to the AES encryption calculation section 301, an input register 303 to hold a plain text which is a subject of encryption in block length units, an IV register 304 to hold an initial vector used in a first encryption calculation, a selector 305 to selectively outputs either the encryption vector to be outputted as a calculation result of the AES encryption calculation section 301 or the initial vector held in the IV register 304, an EXOR calculation section 306 to calculate exclusive OR of an output of the input register 303 and an output of the selector 305, and supply the result to an input of the AES encryption calculation section 301, and an output register 307 to hold an output (encryption result) of the AES encryption calculation section 301.

FIG. 8 shows a process of encryption with the encryption circuit 300 of CBC method. Here, a data block length to be encrypted in an encryption process is 16 bytes and a process of encrypting a total of four K byte is exemplified.

In a first cycle y0, a plain text S[0] in the block length unit set in the input register 303 and the initial vector IV[0] held in the IV register 304 are inputted to the EXOR calculation section 306 and exclusive OR is calculated. The AES encryption calculation section 301 inputs the output of the EXOR calculation section 306 and the encryption key (KEY) held in the KEY register 302 and carries out encryption calculation, then outputs the calculation result D[0] to the output register 307 and the selector 305.

In a Nth cycle yN (N≧2) after second cycle, instead of the initial vector IV [0], a calculation result D[N−1] of last cycle is selected by the selector 305 and encryption processing is carried out. Namely, exclusive OR is calculated for a plain text S[N] set in the input register 303 and the calculation result D[N−1] of the last cycle, then the AES encryption calculation section 301 inputs the output of the EXOR calculation section 306 and the encryption key (KEY) held in the KEY register 302 and carries out encryption calculation and then outputs a calculation result D[N] to the output register 307 and the selector 305.

The FIG. 9 shows a circuit configuration of a decryption circuit 320 of CBC method. The decryption circuit 320 is provided with an AES decryption section 321 to carry out decryption calculation based on AES standard for an input value and to output a calculation result (decryption vector), a KEY register 322 to hold a decryption Key to be inputted to the AES decryption calculation section 321, an input register 323 to hold the cipher text to be decrypted in the block length unit, an IV register 324 to hold an initial vector used in a first decryption calculation, a selector 325 to selectively output either the cipher text held in the input register 323 or the initial vector held in the IV register 324, an EXOR calculation section 326 to calculate exclusive OR of an output of the AES encryption calculation section 321 and an output of the selector 325, and an output register 327 to hold an output (decryption result) of the EXOR calculation section 326.

FIG. 10 shows a process of decryption by the decryption circuit 320 of the CBC method. Here, a process where a cipher text of four K bytes created in the process in FIG. 8 is decrypted successively with respect to each data block of 16 bytes is exemplified.

In the first decryption cycle y0, the AES decryption calculation section 321 inputs the cipher text D[0] in the block length unit set in the input register 323 and the decryption key (KEY) held in the KEY register 322, and conducts decryption calculation. Then the calculation result and the initial vector IV [0] are inputted to the EXOR calculation section 326 and exclusive OR is calculated, and then an output of the EXOR calculation section 326 is outputted to the output register 327 as a plain text S[0].

In a Nth cycle yN (N≧2) after second cycle, instead of the initial vector IV [0], a cipher text D[N−1] of the last cycle is selected by the selector 325 and inputted to the EXOR calculation section 326. Namely, the AES decryption calculation section 321 inputs the cipher text D[N] in the block length unit set in the input register 323 and the decryption key (KEY) held in the KEY register 322 and conducts decryption calculation. Then the calculation result and the cipher text D[N−1] of the last cycle are inputted to the EXOR calculation section 326 and exclusive OR is calculated and then the EXOR calculation section 326 outputs a plain text S[N] to the output register 327.

In the above encryption method, since the subsequent encryption processing is carried out using the last encryption result, the cipher text has to be decrypted from the beginning, thus a portion of cipher text in the middle cannot be solely encrypted or edited. Therefore a file encryption method is suggested that the plain text is divided into a minimum size where an application program may access, the plain text having been divided is encrypted respectively and thereafter, connected to obtained a series of text. so as to enable partial editing, deleting and adding after encryption (for example, refer to Unexamined Japanese Patent Application Publication No. H07-140896).

In case encryption or decryption processing is conducted using the encryption circuit 300 or decryption circuit 320, normally the CPU (Central Processing Unit) at higher level conducts various kinds of setting and initializing before commencing the processing thereof.

Thus, in case the plain text is divided into small units and encrypted, the CPU has to carry out aforesaid initializing and setting processing for each divided unit of the plain text therefore there is a problem that loads applied to the CPU increase.

For example, as FIG. 11 shows, in case data of four K byte is divided into data of 512 byte to be encrypted, the CPU has to carry out 8 times of software processing W such as initializing and setting, thus processing load of the CPU increases and an overhead burden due to software processing increases, and as a result there is a problem that a total processing time of encryption and decryption is lengthened.

### SUMMARY OF INVENTION

To provide the encryption circuit and decryption circuit which relieve the burden of software processing related to initializing, in case the data is initialized with respect to each predetermined size for encrypting or decrypting, the present invention is provided with the following structures.

### <Structure 1>

An encryption circuit, having:

a calculation section for encrypting data using an input vector for calculation;

an initial register for holding the initial vector;

a changeover section for selecting given data created or used in last encryption processing through the calculation section or the initial vector which the initial register outputs, and for supplying the data thereof to the calculation section as the input vector; and

a control section for controlling the changeover section so that the initial vector is selected at a first encryption and in a predetermined cycle.

### <Structure 2>

A decryption circuit having:

a calculation section for decrypting data using an input vector for calculation;

an initial register for holding the initial vector;

a changeover section for selecting given data created or used in last decryption processing through the calculation section or the initial vector which the initial register outputs and supplying the data thereof to the calculation section as the input vector; and

a control section for controlling the changeover section so that the initial vector is selected at a first decryption and in a predetermined cycle.

### BRIEF DESCRIPTION OF THE DRAWINGS

FIG. 1 is a block diagram showing a configuration of an encryption circuit related to an embodiment of the present invention.

FIG. 2 is a flow chart showing an entire encryption processing by an encryption circuit related to an embodiment of the present invention.

FIG. 3 is an explanatory diagram showing an encryption processing by an encryption circuit related to an embodiment of the present invention.

FIG. 4 is a block diagram showing a configuration of a decryption circuit related to an embodiment of the present invention.

FIG. 5 is a flow chart of an entire decryption processing by a decryption circuit related to an embodiment of the present invention.

FIG. 6 is an explanatory diagram showing decryption processing by a decryption circuit related to an embodiment of the present invention.

FIG. 7 is a circuit configuration diagram showing a conventional encryption circuit.

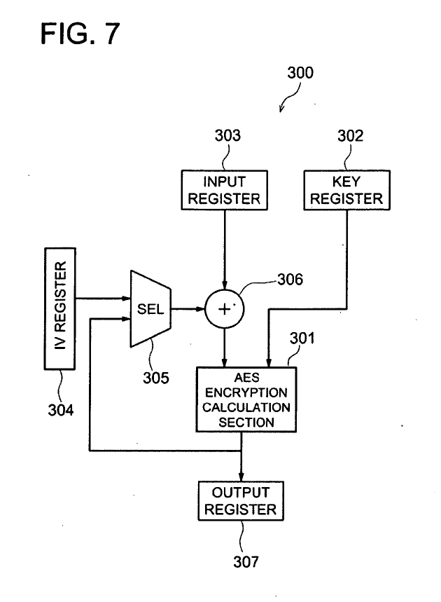

FIG. 8 is an explanatory diagram showing encryption processing by the encryption circuit shown in FIG. 7.

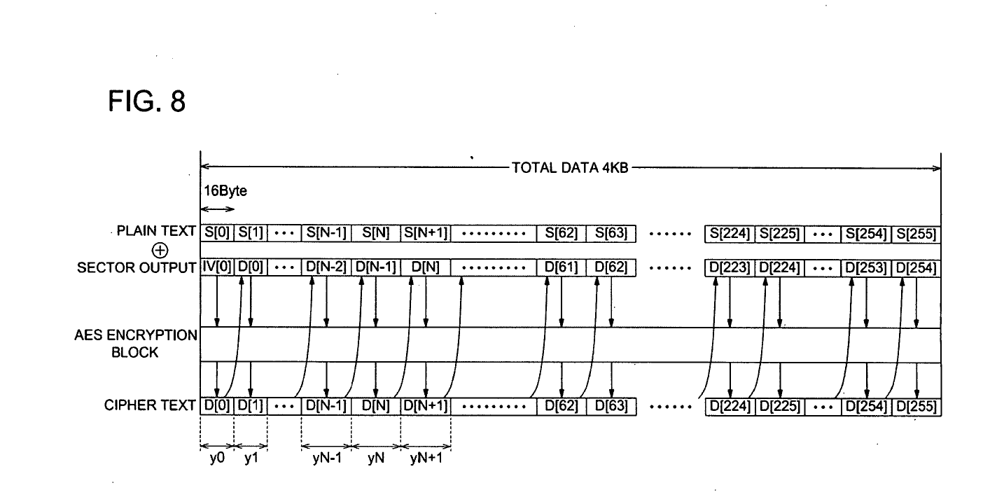

FIG. 9 is a circuit configuration diagram showing a conventional decryption circuit.

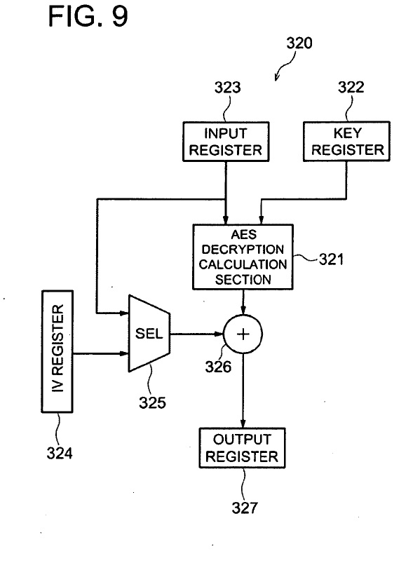

FIG. 10 is an explanatory diagram showing decryption processing by the decryption circuit shown in FIG. 9.

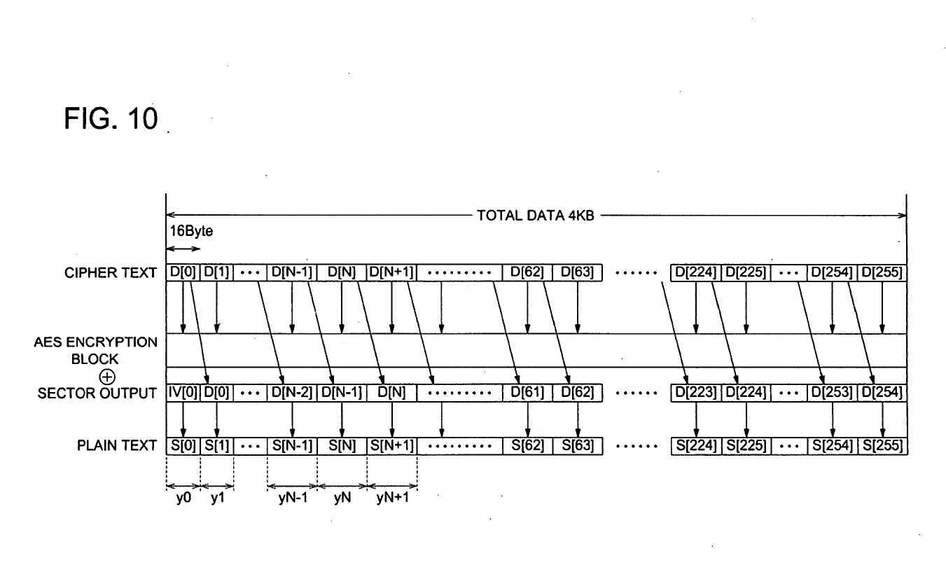

FIG. 11 is an explanatory diagram showing an exemplary processing, in case initiation processing with respect to each dividing unit is carried out by software processing through a CPU when a plain text is divided plurally and encrypted respectively.

### DETAILED DESCRIPTION OF THE PREFERRED EMBODIMENT

The encryption circuit 10. and decryption circuit 50 related to the present invention are described with reference to the figures. The encryption circuit 10 and decryption circuit 50 are installed in an image forming apparatus such as a digital multi-functional peripheral equipped with a copying function where a document is read and a corresponding image is formed on a recording sheet to be outputted, a scanning function, printing function and facsimile function, and the circuits thereof are used for encryption and decryption of image data to be stored in a hard disk device of the image forming apparatus thereof.

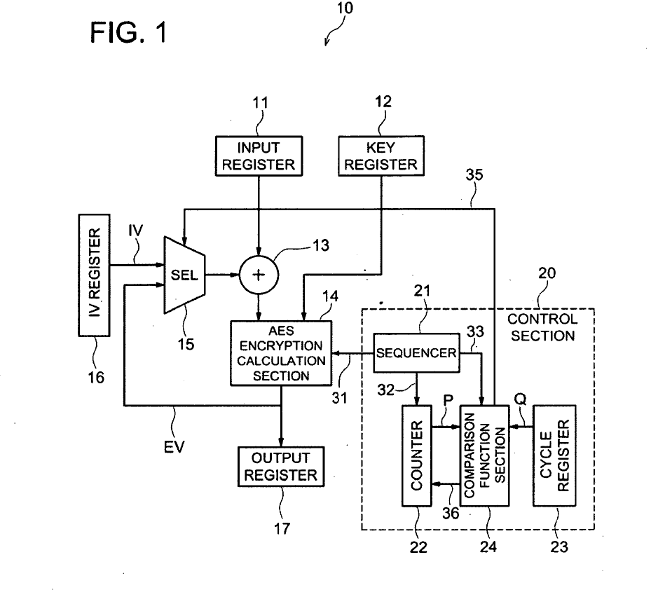

FIG. 1 is a block diagram showing a structure of the encryption circuit 10 related to the embodiment of the present invention. The encryption circuit 10 applies encryption processing for data to be encrypted (plain text) in block length unit of 128 bit (16 byte) based on AES standard. The encryption circuit 10 is equipped with an input register 11, a KEY register 12, an EXOR calculation section 13 and AES encryption calculation section 14 configuring a calculation section, a selector 15, an IV register 16, an output register 17 and a control section 20.

The control section 20 is equipped with a sequencer 21, a counter 22, a cycle register 23 and a comparison function section 24.

AES encryption calculation section 14 is a circuit to conduct a predetermined block encryption calculation based on AES standard. The KEY register 12 is a register to hold an encryption key and the encryption key held in the KEY register 12 is inputted in the AES encryption calculation section 14. The input register 11 is a register to hold the subject data to be encrypted by the block length unit.

IV register 16 is a register to hold an initial vector IV. The selector 15 selectively outputs the initial vector IV which the IV register outputs or an output value (encryption victor EV) which the AES encryption calculation section 14 outputs as a calculation result. An output of the selector 15 and an output of the input register 11 are inputted to the EXOR calculation section 13 and the EXOR calculation section 13 conducts calculation of excusive OR of these inputs. The output of the EXOR calculation section 13 is inputted to the AES encryption calculation section 14. An output of the AES encryption calculation section 14 is further inputted to the output register 17. The output register 17 outputs a cipher text (encrypted vector) to outside.

The sequencer 21 is a sequencer to operated the AES encryption calculation section 14 and outputs a control signal 31 to the AES encryption calculation section 14. Also, the sequencer 21 outputs a completion signal 32 to a counter 22 every time the encryption vector EV is outputted when encryption processing for one block is completed in the AES encryption calculation section 14. The AES encryption calculation section 14 conducts encryption calculation (one cycle) predetermined times to carry out encryption for one block length (16 byte). Also, the sequencer 21 outputs an initial signal 33 to the comparison function section 24 when a succession of encryption processing is started.

The counter 22 counts the number of input times of the completion signal 32 inputted from the sequencer 21. Thus, the AES encryption calculation section 14 counts the number of times of the encryption processing (encryption times) for one block length.

In the cycle register 23, there is set a value (set number of encryption times) which is the number of times of encryption converted from data size of the encryption subject data to be encrypted in one cycle. For example, given that one block length to be encrypted in one encryption processing is 16 byte, and data of 512 bytes is encrypted in one cycle, set number of encryption times “32” is obtained by dividing 512 bytes by 16 bytes.

The comparison function section 24 compares the count value P of the counter 22 and the set number of encryption times Q set in the cycle register 23, and then outputs an enable signal 35 to the selector 15 if the values thereof equate. When this occurs, the comparison function section 24 outputs a reset signal 36 to the counter 22. The selector 15 selectively outputs the initial vector IV when the enable signal 35 is inputted and selectively outputs the encryption vector EV inputted from the AES encryption calculation section 14 when the enable signal is not inputted. Also, the comparison function section 24 outputs the enable signal 35 when the initial signal 33 is inputted from the sequencer 21.

Setting of data in the KEY register 12 and the IV register 16, and setting of set the number of encryption times in the cycle resister 23 as well as setting and starting of the sequencer 21 are conducted by an unillustrated CPU at a higher level. Also, a job to successively set the encryption subject data for the input register 11 and a job to successively read out data (cipher text) from the output register 17 are conducted by, for. example, the data transmission section (unillustrated) such as DMA controller to input and output data to/from a data compression/expansion section or the hard disk device.

Next, operation of encryption processing by the encryption circuit 10 will be described.

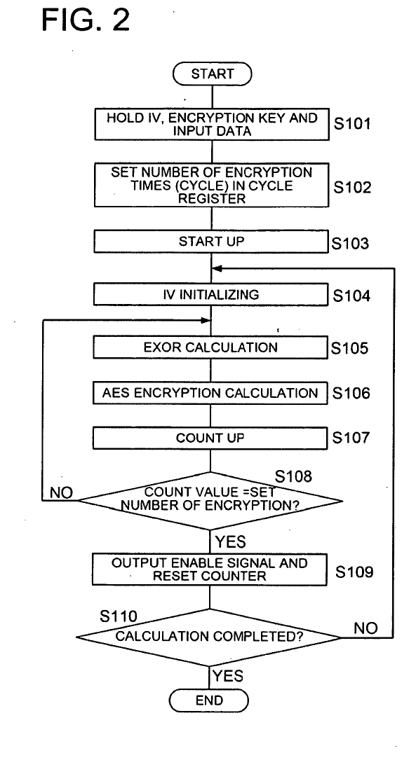

FIG. 2 shows a series of encryption processing flow using the encryption circuit 10. First, the CPU sets the initial vector IV for the IV register 16, and sets the encryption key for the KEY register 12. Further, the encryption subject data is set in the input register 11 (Step S101). Meanwhile, setting of the encryption subject data in the input register 11 and reading out of cipher text from the output register 17 are carried out successively from outside in accordance with progress of the encryption processing in the encryption circuit 10.

Next, the CPU sets a set number of encryption time for the cycle register 23 (step S102). Here, the value of the set number of encryption times is determined so that the data size of encryption data outputted from the encryption circuit 10 in one cycle agrees with the sector size of the memory device (hard disk device) in which the encryption data is stored. For example, given that the sector size is 512 bytes, a quotient “32” which is a result of dividing the sector sized of 512 bytes by one block length of 16 bytes is set as the set number of encryption times.

After carrying out the above setting, the CPU outputs a start instruction of the series of encryption processing to the sequencer 21 (Step S103).

After receiving the start instruction, the sequencer 21 outputs initial signal 33 to cause the comparison function section 24 to output the enable signal 35 to the sector 15, and to cause the selector 15 to selectively output the initial vector IV (which is called IV initialization)(Step S104).

The EXOR calculation section 13 conducts exclusive calculation on the initial vector IV outputted from the selector 15 and an output value (encryption subject data) of the input register 11 (Step S105), and AES encryption calculation section 14 inputs the output of the EXOR calculation section 13 and the output of KEY register 12 and carries out encryption calculation, then outputs the encryption vector (cipher text) by one block (Step S106). Also, the encryption vector is inputted to the selector 15 as well.

When encryption processing for first one block is completed, the sequencer 21 turns off the initial signal 33 and outputs completion signal 32. The counter 22 counts the completion signal 32 (Step S107). The comparison function section 24 compares a count value P of the counter 22 and an output (the set number of encryption times) Q of the cycle register 23 (Step S108).

In case the count value P of the counter 22 and the set number of encryption times Q do not agree (Step S108; N), the comparison function section 24 does not output the enable signal 35. Thereby, the selector 15 selectively outputs the encryption victor EV representing the result of current calculation outputted from the AES encryption calculation section 14. In this state, next calculation is conducted by the EXOR calculation section 13 and the AES encryption calculation 14 (Steps S105 and S106).

Namely, exclusive OR on the output value of the input register 11 and the last encryption vector EV outputted form the AES encryption calculation section 14 is calculated, and the result of the calculation is inputted to the AES encryption section 14 then a new encryption vector is created.

In case the count value P of the counter 22 and the set number of encryption times Q agree (Step 108; Y), the comparison function section 24 outputs a reset signal 36 to the counter 22 to initialize the count value of the counter “0” (Step S109). Also, the comparison function section 24 outputs the enable signal 35, and the selector 15 having received the signal thereof selectively outputs the initial vector IV (Step S104). In this state, next calculation is conducted by the EXOR calculation section 13 and the AES encryption section 14 (Steps S105 and S106).

Namely, exclusive OR of the output value of the input register 11 and the initial vector IV is calculated by EXOR calculation section 13 and the calculation result is inputted to the AES encryption calculation section 14 to create a new encryption vector.

The above processing is repeated until the series of encryption processing is completed (for example, encryption processing for 4 K bytes is completed) (step S110; No), and when a scheduled amount of encryption processing is completed, the present processing is terminated (End). Meanwhile, the encryption circuit 10 does not judge completion of encryption by itself, the series of encryption processing is practically terminated by ceasing next data to be set in the input register 11 from outside.

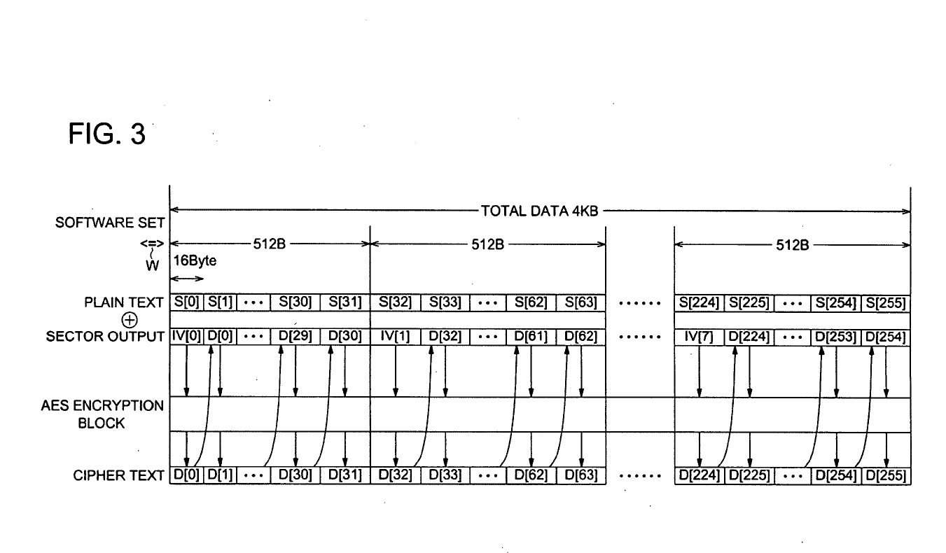

FIG. 3 shows a process in the encryption circuit 10 in case data of 4K bytes are encrypted in a state where the number of encryption times is set at “32” so that the number of the encryption data in a cycle becomes 512 bytes. The initial vector IV is selectively outputted from the selector 15 at a first encryption and in a cycle set (512 bytes, in every 32 times of encryption processing) and the exclusive OR calculation with the plain text is carried out.

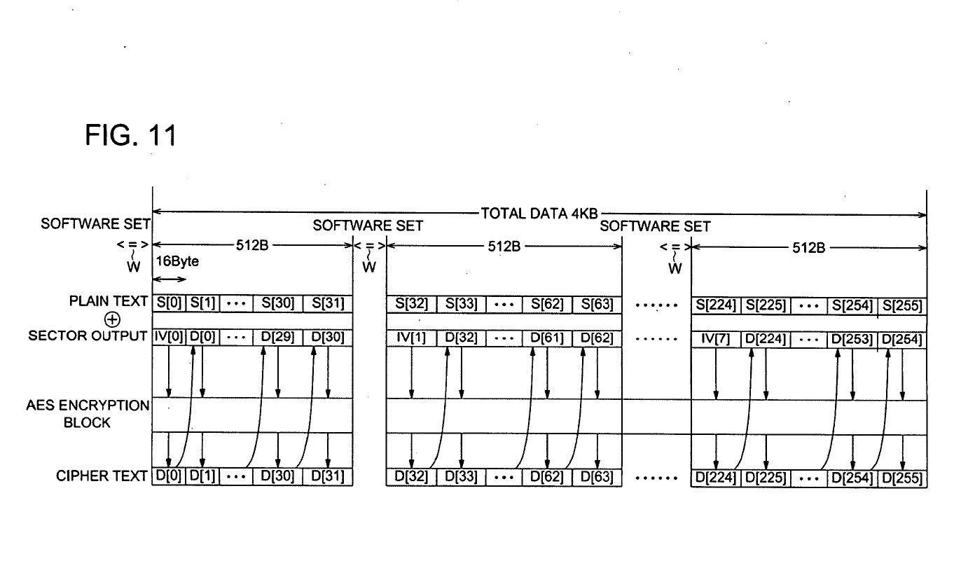

As above, in the encryption circuit 10, by conducting software processing W by the CPU once at starting, thereafter the cipher text initialized for every predetermined size (the size shown by the set number of encryption times Q) can be automatically obtained by a series of processing with hardware. As FIG. 11 shows, compared with a case where software processing W by the CPU is carried out for every encryption of each plain text having been divided, the number of execution times of software processing w is reduced and the burden of the software can be relieved. Also, overhead due to software processing W is reduced and the processing time of the whole encryption processing can be shortened.

Next, decryption circuit 50 will be described.

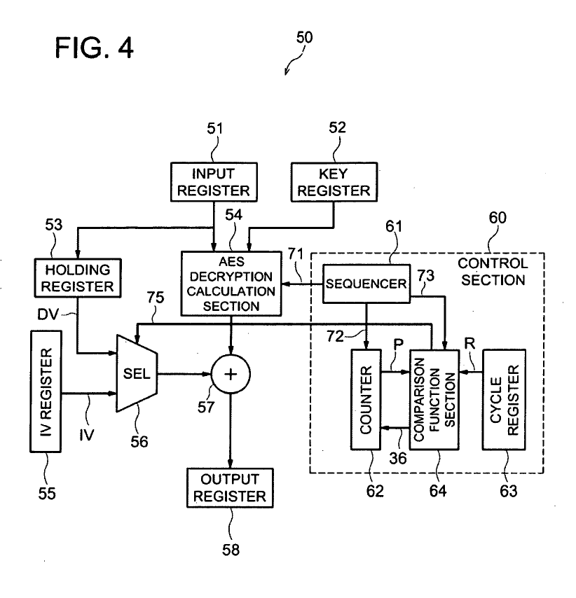

FIG. 4 is a block diagram showing a configuration of the decryption circuit 50 related to the embodiment of the present invention. The decryption circuit 50 is a circuit to apply decryption processing for decryption subject data (cipher text) by a block length of 128 bit (16 bytes) based on the AES standard. The decryption circuit 50 is equipped with an input register 51, a KEY register 52, a holding register 53, an AES decryption calculation section 54, an IV register 55, a selector 56, an EXOR calculation section 57, an output register 58 and a control section 60.

The control section 60 is equipped with a sequencer 61, a counter 62, a cycle register 63 and a comparison function section 64.

The AES decryption calculation section 54 is a circuit to execute a predetermined block encryption calculation based on the AES standard. The KEY register 52 is register to hold a decryption key. The input register 51 is a register to hold the decryption subject data by the block length. An output of the input register 51 and an output of the KEY register 52 are inputted to the AES decryption calculation section 54. Also, the output of the input register 51 is inputted to the holding register 53 as well. The holding register 53 functions to delay the data (cipher text) inputted from the input register 51 by one cycle (processing time period in which the AES decryption calculation section 54 decrypts one block of a cipher text) and output.

The IV register 55 is a register to hold the initial vector IV. The selector 56 selectively outputs either the initial vector IV which the IV register 55 outputs or an output value DV of the holding register 53. The output of the selector 56 and the calculation result outputted by the AES decryption calculation section 54 are inputted to the EXOR calculation section 57 and the EXOR calculation section 57 executes exclusive OR of both inputs. An output of the EXOR calculation section 57 is inputted to the output register 58. A plain text after having been decrypted is outputted from the output register 58 to outside.

The sequencer 61 is a sequencer to operate the AES decryption calculation section 54 and outputs a control signal 71 to the AES decryption calculation section 54. Also, the sequencer 61 outputs a completion signal 72 to a counter 62 every time calculation results are outputted when decryption processing for one block is completed in the AES decryption calculation section 54. The AES decryption calculation section 54 conducts decryption calculation (one cycle) predetermined times to decrypt the text by one block length (16 byte). Also, the sequencer 61 outputs an initial signal 73 to the comparison function section 64 when a succession of decryption processing is started.

The counter 62 counts the number of times of input of the completion signal 72 inputted from the sequencer 61. Thus, the counter 62 counts the number of times of the decryption processing carried out by the AES decryption calculation section 54 (number of decryption times) for one block length.

In the cycle register 63, a value (set number of decryption times) which is the number of times of decryption converted from data size of the decryption subject data to be decrypted in one cycle is set. For example, given that 16 bytes (one block length) is decrypted in one decryption processing, and 512 bytes are decrypted in one cycle, a set number of decryption times “32” is obtained by dividing 512 bytes by 16 bytes.

The comparison function section 64 compares the count value P of the counter 62 and the set number of decryption time R set in the cycle register 63 and outputs an enable signal 75 to the selector 56, if the values thereof agree. When this occurs, the comparison function section 64 outputs a reset signal 76 to the counter 62. Selector 56 selectively outputs the initial vector IV when the enable signal 75 is inputted and selectively outputs the cipher text of last cycle inputted from the holding register 53 when the enable signal is not inputted. Also, the comparison function section 64 outputs the enable signal 75 when the initial signal 73 is inputted from the sequencer 61.

Setting of data in the KEY register 52 and the IV register 55, setting of the set number of decryption times in the cycle resister 63 and setting and starting for the sequencer 61 are conducted by an unillustrated CPU at the higher level. Also, a job to successively set the decryption subject data for the input register 51 and a job to successively read out data from the output register 58 are conducted by, for example, the data transmission section (unillustrated) such as a DMA controller to input and output data to/from a data compression/expansion section of the hard disk device.

Next, operation of decryption processing by decryption circuit 50 will be described.

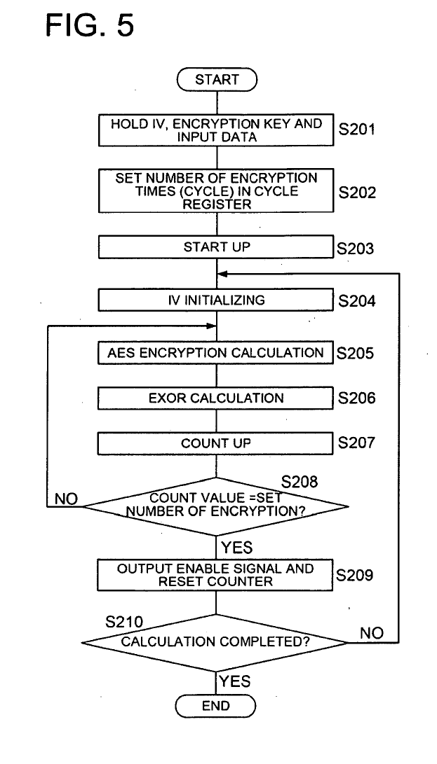

FIG. 5 shows a series of decryption processing flow by the decryption circuit 50. First, the CPU sets the initial vector IV for the IV register 55, and sets the decryption key for the KEY register 52. Further, the decryption subject data (cipher text) is set in the input register 51 (Step S201). Meanwhile, setting of the decryption subject data in the input register 51 and reading out of plain text from the output register 58 are carried out successively from outside in accordance with progress of the decryption processing in the decryption circuit 50.

Next, the CPU sets set number of decryption times for the cycle register 63 (Step S202). Here, the cipher text representing the decryption subject is a text having been encrypted by the encryption circuit 10, and the same value as that of the set number of encryption times when the encryption circuit 10 encrypted is set as the set number of decryption times.

After carrying out the above setting, the CPU outputs a start instruction of the series of decryption processing to the sequencer 61 (Step S203).

After receiving the start instruction, the sequencer 61 outputs initial signal 73 to cause the comparison function section 64 to output the enable signal 75 to the sector 56, and to cause the selector 56 to selectively output the initial vector IV (this state is called IV initialization)(Step S204).

The AES decryption calculation section 54 inputs an output of the KEY register 52 and an output of the input register 51, and applies decryption calculation for a cipher text inputted from the input register 51 based on the inputs thereof (Step S205). When this occurs, the output of the input resister 51 is held in the holding register 53 and outputted from the holding register 53 with a delay by one cycle of the decryption processing.

The EXOR calculation section 57 conducts exclusive OR calculation of the initial vector IV selectively outputted from the selector 56 and an output value of the AES decryption calculation section 54 (Step S206) and outputs a plain text by one block as the calculation result. The plain text is outputted outside from the output register 58.

When decryption processing for first one block is completed, the sequencer 61 turns off the initial signal 73 and outputs completion signal 72. The counter 62 counts the completion signal 72 (Step S207). The comparison function section 64 compares a count value P of the counter 62 and an output (set number of decryption times) R of the cycle register 63 (Step S208).

In case the count value P of counter 62 and the set number of decryption times R do not agree (Step S208; N), the comparison function section 64 does not output the enable signal 75. Thereby, the selector 56 selectively outputs the output value of the holding register 53 to the EXOR calculation section 57. In this state, next calculation is carried out (Steps S205 and S206).

Namely, the output of the input register 51 is decrypted through the AES decryption calculation section 54, and the output of the AES decryption calculation section 54 and the last cipher text held in the holding register 53 of exclusive OR is calculated so as to create a new plain text.

In case the count value P of the counter 62 and the set number of decryption times R agree (Step 208; Y), the comparison function section 64 outputs a reset signal 76 to the counter 62 to initialize the count value of the counter “0” (Step S209). Also, the comparison function section 64 outputs the enable signal 75, and the selector 56 having received the signal thereof selectively outputs the initial vector IV to EXOR calculation section 57 (Step S204). In this state, next calculation is carried out (Steps S205 and S206).

Namely, the output of the input register 51 is decrypted by the AES decryption calculation section 54, and EXRO calculation section 57 conducts the exclusive OR calculation of the output of the AES decryption calculation section 54 and the initial vector IV to create a new plain text.

The above, processing is repeated until the series of decryption processing is completed (for example, decryption processing for 4 K bytes is completed) (Step S210; No), and when a scheduled amount of decryption processing is completed, the present processing is terminated (End). Meanwhile, the decryption circuit 50 does not judge completion of decryption by itself, the series of decryption processing is practically terminated by ceasing next data to be set in the input register 51 from outside.

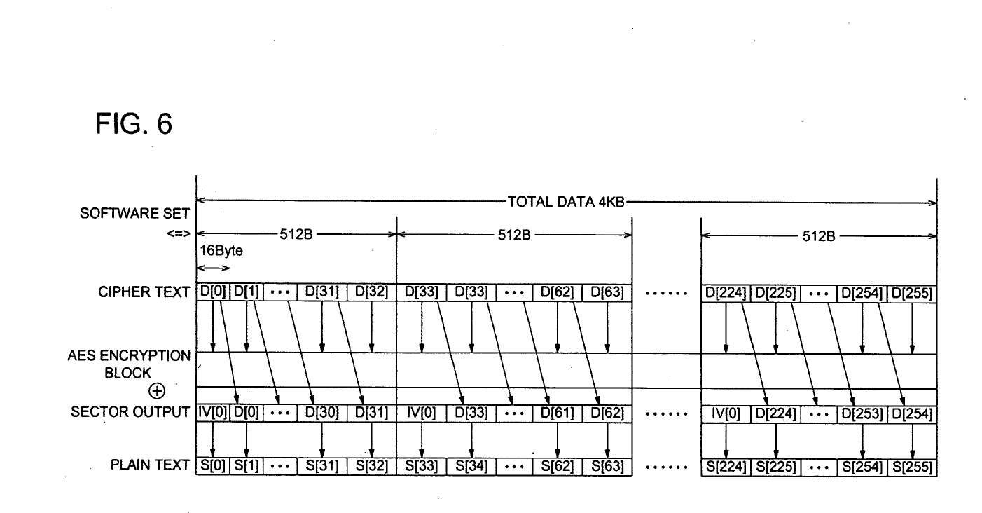

FIG. 6 shows a process in which the decryption circuit 50 decrypts a cipher text of 4K bytes which has been encrypted by the encryption circuit 10 by setting (the number of encryption times to be “32”) so that the number of encryption data becomes 512 byte in one cycle. The initial vector IV is selected and inputted to the EXOR calculation section 57 at the first decryption and at set cycle (512 bytes, at every 32 times of decryption).

As above, in the decryption circuit 50, by conducting software processing W by CPU once at starting, thereafter, a series of cipher text initialized and encrypted for every predetermined size can be continuously decrypted by a series of processing with hardware. Compared to a case where initialization of decryption is conducted by the software, every time the text in a predetermined size is decrypted, burden of software processing is reduced and overhead due to software processing W is reduced, as a result the processing time of the whole decryption processing can be shorten.

The embodiments of the present invention has been described with reference to the drawings without the specific structures being restricted thereto, and it is to be understood that changes and variations made without departing from the spirit or scope are included in the present invention.

In the embodiment, while the encryption circuit 10 and the decryption circuit 50 are exemplified, the encryption method is not limited to CBC as far as the encryption method uses a predetermined data created or used in last encryption process or decryption process for encryption or decryption. For example, the present embodiment can be applied for OFB (Output Feed Back) mode. Meanwhile, the predetermined data created or used in the last encryption or decryption can be varied according to the encryption method. For example, the data can be a plain text used in the last encryption, a cipher text created in the last encryption, an intermediate vector (for example, data outputted from the AES calculation section at the time of encryption of OFB mode) created in a middle of steps of last encryption, a cipher text used in last decryption, and a plain text created in last decryption (for example, data outputted from the aforesaid AES calculation section at time of decryption of OFB method).

The configuration of the control section 20 and control section 60 shown in the embodiments are the examples, and other configurations are possible as far as the circuits have functions to execute IV initializing automatically within the set cycle.

According to one aspect of the present invention, when a series of encryption processing is executed, the initial vector is automatically selected at a first encryption and in a predetermined cycle. Therefore the cipher text outputted is a cipher text having been initialized by the initial vector with respect to each predetermined size corresponding to the cycle, and encrypted then, a job of the software initializing for each predetermined size is not necessary.

According to another aspect of the present invention, when the data to be decrypted is decrypted, the initial vector is automatically selected at the first decryption and in the predetermined cycle. When a series of cipher text, which is initialized with respect to each predetermined size and encrypted such as the cipher text encrypted by the encryption circuit of the present invention, the initial vector is automatically selected at the first decryption of the cipher text in to each predetermined size and processed. Thereby a job such as software initializing for every decryption in the predetermined size, is not necessary.

According to the encryption processing apparatus related to the present invention, data can be encrypted or decrypted for each predetermined size without burden of software processing being increased. Also, since encryption or decryption for each predetermined size can be carried out continuously and automatically, overhead related to setting in software processing is reduced, thus the processing time of encryption and decryption is reduced by an amount for the overhead.

What is claimed is:

1. An encryption circuit, comprising:
a calculation section for encrypting data using an input vector for calculation;
an initial register for holding an initial vector;
a changeover section for selecting given data created or used in last encryption processing through the calculation section or the initial vector which the initial register outputs, and supplying the selected data thereof to the calculation section as the input vector; and
a control section for controlling the changeover section so that the initial vector is selected at a first encryption and in a predetermined cycle.

2. The encryption circuit of claim 1, wherein the control section comprises a counter for counting number of encryption times in the calculation section; a cycle register to which the number of encryption times indicating the cycle is set; and a comparison section for comparing a count value of the counter and an output value of the cycle register; and the control section controls the changeover section so as to select the initial vector in case the count value of the counter and the output value of the cycle register agree, and then resets the counter.

3. The encryption circuit of claim 1, wherein the cycle is set so that a data size of encryption data outputted from the calculation section within a last cycle agrees with a sector size of a memory device in which the encryption data outputted from the calculation section is stored.

4. A decryption circuit comprising:
a calculation section for decrypting data using an input vector for calculation;
an initial register for holding an initial vector;
a changeover section for selecting given data created or used in last decryption processing through the calculation section or the initial vector which the initial register outputs, and supplying the selected data thereof to the calculation section as the input vector; and
a control section for controlling the changeover section so that the initial vector is selected at a first decryption and in a predetermined cycle.

5. The encryption circuit of claim 4, wherein the control section comprises a counter for counting number of decryption times in the calculation section; a cycle register to which the number of decryption times indicating the cycle is set; and a comparison section for comparing a count value of the counter and an output value of the cycle register; and the control section controls the changeover section so as to select the initial vector in case the count value of the counter and the output value of the cycle register agree, and then resets the counter.
